(19) United States
(12) Patent Application Publication
(10) Pub. No.: US 2008/0273953 A1
(43) Pub. Date: Nov. 6, 2008

(54) Modular wall transport device

(75) Inventors: Paul Bodem, Chaska, MN (US); Brian Ketel, Blaine, MN (US); Brian James Strempke, Circle Pines, MN (US); Christopher Jon Altringer, Circle Pines, MN (US); Jeffory Allen Morness, Owatonna, MN (US); Kevin C. Speltz, Lino Lakes, MN (US); Nate R. Perkins, St. Paul, MN (US); Ryan Lee Jacobi, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: DePaul Construction Company, Chaska, MN (US)

(21) Appl. No.: 11/799,297

(22) Filed: May 1, 2007

(51) Int. Cl. B60P 3/022

(52) U.S. Cl. 414/382

(57) ABSTRACT

A wall transport device comprises a base, a plurality of wheels positioned below the base, a steering assembly attached to the base, and a wall support pivotally connected to the base. The wall support includes a telescoping mast, a top hook, and a bottom flange. A first mechanism tilts the wall support between a proximal and a distal position. A second mechanism raises and lowers the top hook.

### BACKGROUND

The present invention is a modular wall transport device. More specifically, the present invention is a device that can be used to safely and efficiently transport a modular wall at a job site.

Due to the ease of installation and resulting time that is saved, modular or prefabricated walls are often used for construction projects. However, modular wall panels are heavy and unwieldy. Therefore, a crane is sometimes used to transport the wall panels, which is costly. In the alternative, the wall panels are manually transported. Manually transporting these panels around a job site is a physically demanding and dangerous process. Even when an adequate number of laborers are available to assist with the transport, injuries can occur. One reason these injuries may occur is because this type of transport requires at least four people (one person positioned at each corner) to coordinate their movements, which is difficult. Furthermore, productivity on the project is diminished because when the walls are transported manually multiple laborers must concentrate their efforts on the same task.

As a result, there is a need in the art for a modular wall transport device, which allows a modular wall to be safely transported. In addition, there is a need in the art for a modular wall transport device, which reduces the manual labor requirement and increases efficiency and productivity by allowing smaller construction crews to perform the same job with fewer laborers.

### SUMMARY

The present invention is a wall transport device, which comprises a base, a plurality of wheels positioned below the based a steering assembly attached to the base, and a wall support pivotally connected to the base. The wall support includes a telescoping mast, a top hook, and a bottom flange. A first mechanism tilts the wall support between a proximal and a distal position. A second mechanism raises and lowers the top hook.

### BRIEF DESCRIPTION OF THE DRAWINGS

FIG. 1 is a side view of a first embodiment of a wall transport device positioned to load a wall.

FIG. 2 is a perspective view of the first embodiment of a wall transport device positioned to transport a wall.

FIG. 3 is a rear view of the first embodiment of a wall transport device positioned to transport a wall.

FIG. 4 is a perspective view of a second embodiment of a wall transport device.

FIG. 5 is a front view of the second embodiment of a wall transport device.

FIG. 6 is a rear view of the second embodiment of a wall transport device.

FIG. 7 is a side view of the second embodiment of a wall transport device.

FIG. 8 is a bottom view of the second embodiment of a wall transport device.

FIG. 9 is a schematic diagram of a hydraulic pump system used in the second embodiment of a wall transport device.

FIGS. 10a-10b demonstrate the operation of the second embodiment of a wall transport device.

### DETAILED DESCRIPTION

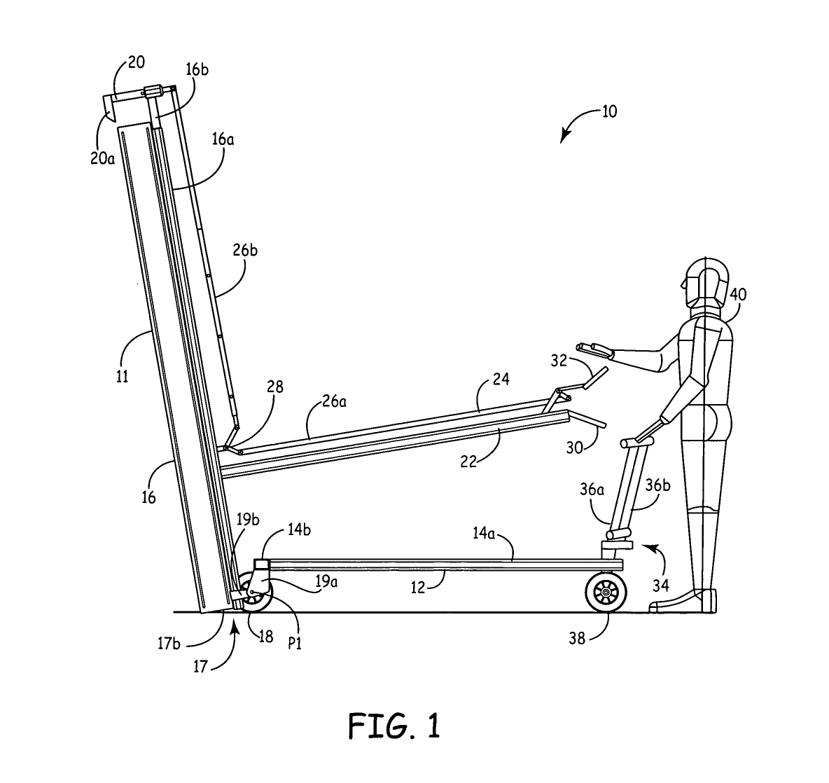

FIG. 1 is a side view of an exemplary embodiment of wall transport device 10, which is positioned to load wall 11. In the embodiment shown in FIG. 1, wall transport device 10 includes base 12 (which is a T-shaped frame formed by longitudinal member 14a and transverse member 14b), telescoping mast 16, angle plate 17, wheels 18, mounting brackets 19a and 19b, and hook 20. Wall transport device 10 also includes first lever 22, second lever 24, first and second rods 26a and 26b, cam 28, first lever handle 30, second lever handle 32, and steering assembly 34, which comprises first and second handles 36a and 36b and steerable wheels 38. Also shown are wall 11, operator 40, and pivot axis P1.

Telescoping mast 16 includes outer sleeve 16a and inner shaft 16b, to which hook 20 is connected. Mast 16 is attached to angle plate 17, which pivotally connected to base 12 through mounting brackets 19a and 19b. Wheels 18 are positioned below transverse member 14b of base 12 and are mounted to angle plate 17 by brackets 19b. Mast 16 and angle plate 17 pivot about pivot axis P1 and wheels 18 rotate about axis P1. Mast 16 and angle plate 17 are shown in a forward tilted position (about 10 degrees from vertical) in FIG. 1.

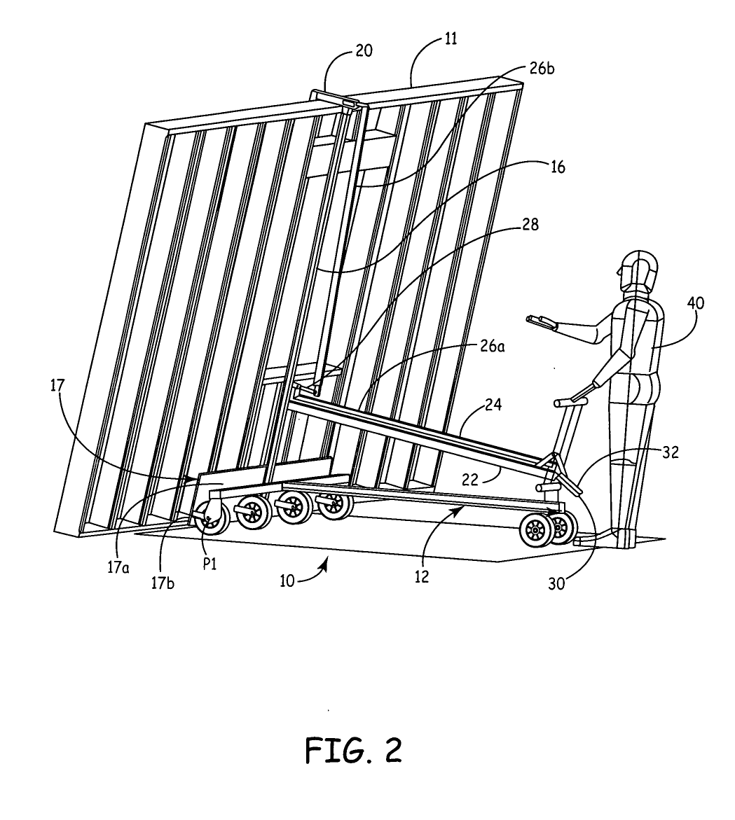

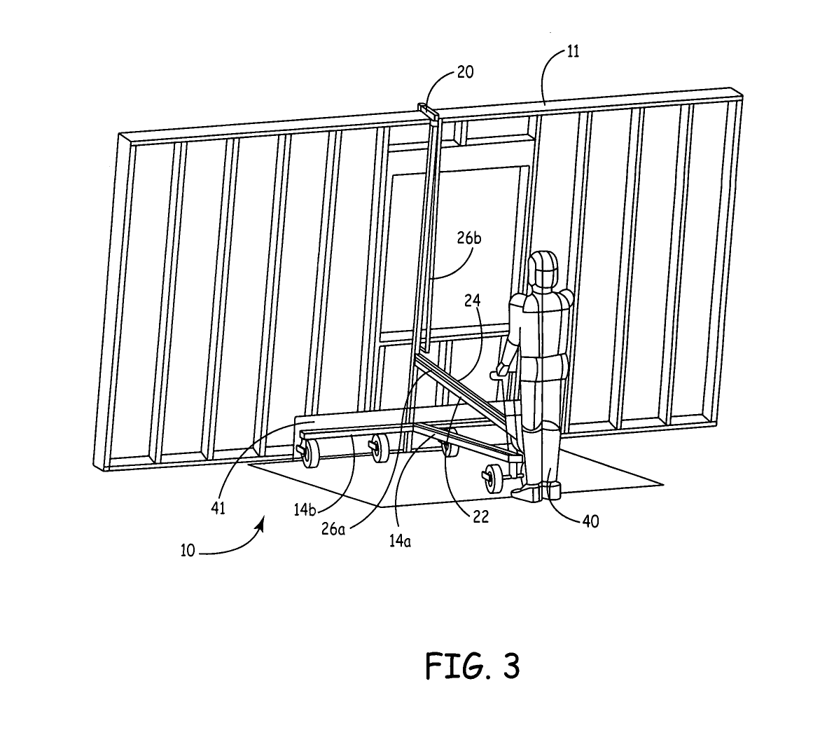

Angle plate 17 includes upright plate 17a (shown in FIGS. 2 and 3 and bottom flange 17b. As shown in FIG. 1, bottom flange 17b is positioned below the bottom end of wall 11.

Lever 22 extends from mast 16. Lever handle 30 is positioned at a proximal end of lever 22. Lever 22 is the mechanism by which mast 16 is pivoted about axis P1 from a forward tilted position shown in FIG. 1 to a rearward tilted position shown in FIGS. 2 and 3. When a downward force is applied to lever handle 30, lever 22 moves in a downward direction and mast 16 is pivoted in a proximal direction from the forward tilted position to the rearward tilted position. In contrast, when an upward force is applied to lever handle 30, lever 22 moves in an upward direction and mast 16 is pivoted in a distal direction from the rearward tilted position to the forward tilted position. Mast 16 is capable of tilting at least 10 degrees in either the distal (forward) or proximal (rearward) direction. In the embodiment shown in FIG. 1, operator 40 has raised lever handle 30 in an upward direction, which results in mast 16 pivoting around pivot axis P1 with respect to base 12. In FIG. 1, mast 16 is tilted about 10 degrees in the distal direction. This allows bottom flange 17b to slide under the bottom end of wall 11 (which typically is stacked in a slightly forward tilted orientation as shown in FIG. 1).

Lever 24 includes a linkage comprised of first and second rods 26a and 26b and cam 28, which extends between first and second rods 26a and 26b. Lever handle 32 is positioned at a proximal end of lever 24. Lever 24 is the mechanism by which hook 20 is raised or lowered. Second rod 26b is attached to hook 20 and inner shaft 16b of telescoping mast 16. When an upward force is applied to lever handle 32, first rod 26a rotates cam 28 such that second bar 26b moves in an upward direction, which raises hook 20. In contrast, when a downward force is applied to lever handle 32, first rod rotates cam 28 such that second bar 26b moves in a downward direction, which lowers hook 20. As shown in FIG. 1, operator 40 has raised lever handle 30 in an upward direction, which results in hook 20 raising upward from mast 16.

Wall transport device 10 also includes steering assembly 34, which allows wall transport device 10 to be easily maneuvered and positioned. Steering assembly 34 comprises first and second handles 36a and 36b and steerable wheels 38. First and second handles 36a and 36b extend in an upward direction and are formed to allow operator 40 to comfortably grasp them. Wheels 38 are pivotally attached to longitudinal member 14a of base 12 and are connected to first and second handles 36a and 36b. Steering assembly 34 is capable of rotating about a vertical axis with respect to base 12. As operator 40 rotates first and second handles 36a and 36b, wheels 38 rotate accordingly. Steering assembly 34 has a range of motion of about 180 degrees. This allows operator 40 mote maneuverability of wall transport device 10.

In FIG. 1, operator 40 has positioned wall transport device 10 using steering assembly 34 so that wall transport device 10 is positioned against wall 11. Wall 11 is stacked (against a vertical surface or another wall section, not shown) so that it is tilted about 10 degrees in the distal direction. Once wall transport device 10 is properly positioned, wall transport device 10 is advanced such that flange 17b slides under a bottom end of wall 11. Since mast 16 has been tilted about 10 degrees in the proximal direction, mast 16 and angle plate 17 fit snuggley against wall 11. Hook 20 is positioned above wall 11 and then is moved downward so that wall 11 is clamped between hook 29 and bottom flange 17b. In this clamping process, only tooth 20a of hook 20 may engage the upper end of wall 11, but that will provide adequate clamping to allow wall 11 to be tilted rearwardly. Once wall 11 is tilted rearwardly, hook 20 can be repositioned so that tooth 20a engages the side rather than the top of wall 11.

FIG. 2 is a perspective view and FIG. 3 is a rear view of wall transport device 10 positioned to transport wall 11. Angle plate 17, wheels 18, and mounting brackets 19a and 19b are shown in more detail in FIGS. 2-3.

As shown in FIGS. 2-3, operator 40 has applied a downward force to lever handle 32, which causes first rod 26a to rotate cam 28 such that second bar 26b moves in a downward direction. As a result, hook 20 is lowered to secure wall 11 in place against mast 16 and angle plate 17, with wall 11 clamped between hook 20 and bottom flange 17b. Once wall 11 is secured, operator 40 may apply a downward force to lever handle 30. As a result, lever 22 moves in a downward direction and wall 11 along with mast 16 and angle plate tilts in a proximal direction.

Operator 40 can now safely and efficiently transport wall 11. When wall 11 is properly positioned at the installation site, operator 40 may once again apply an upward force to lever handle 30, which results in wall 11 tilting in a proximal direction until flange 19 is withdrawn from under the lower edge of wall 11. Wall 11 may then be positioned upright with hook 20 still in place for security purposes. Operator 40, or other workers, can now safely nail/bolt wall 11 into place. When wall 11 is installed, operator 40 may apply an upward force to lever handle 32 to raise hook 20, thus separating wall transport device 10 from wall 11.

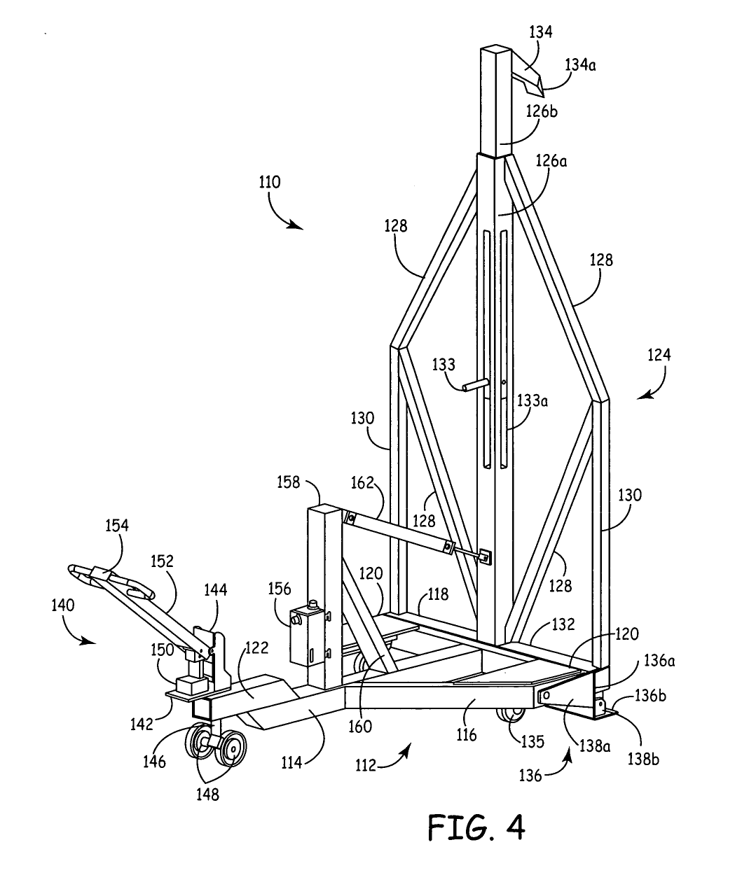

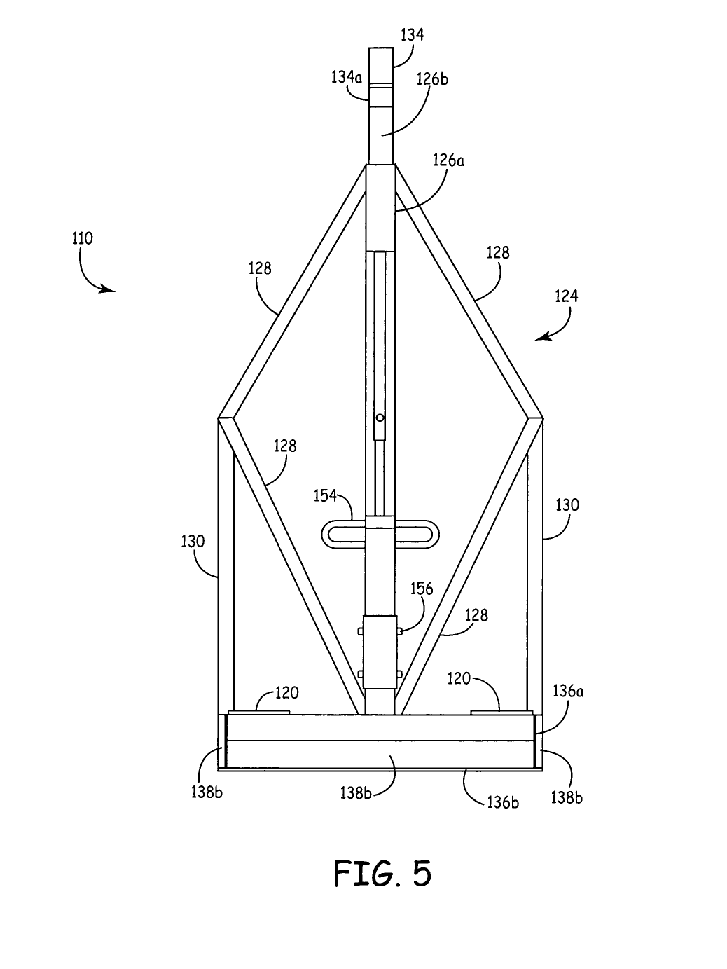

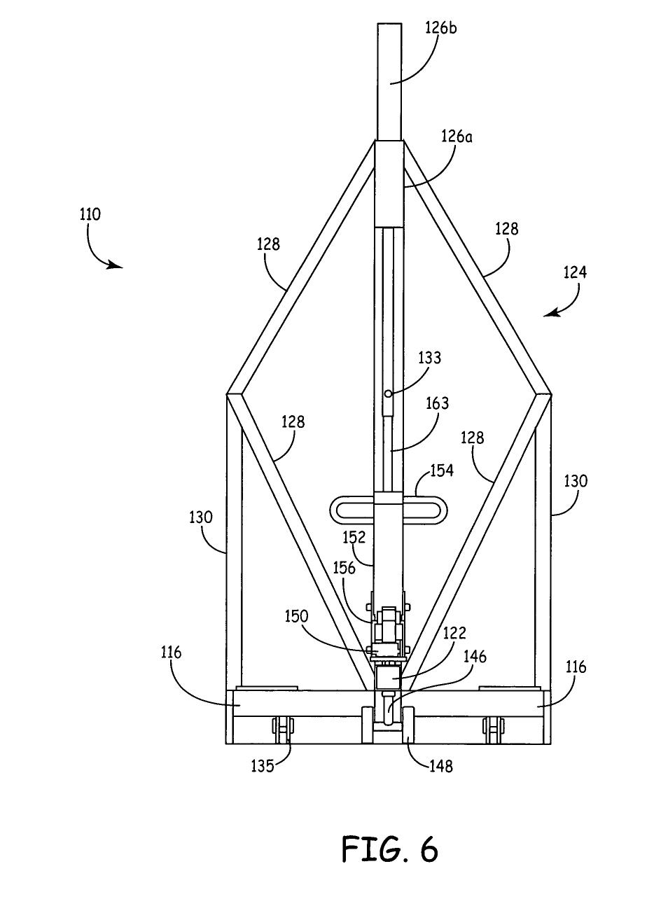

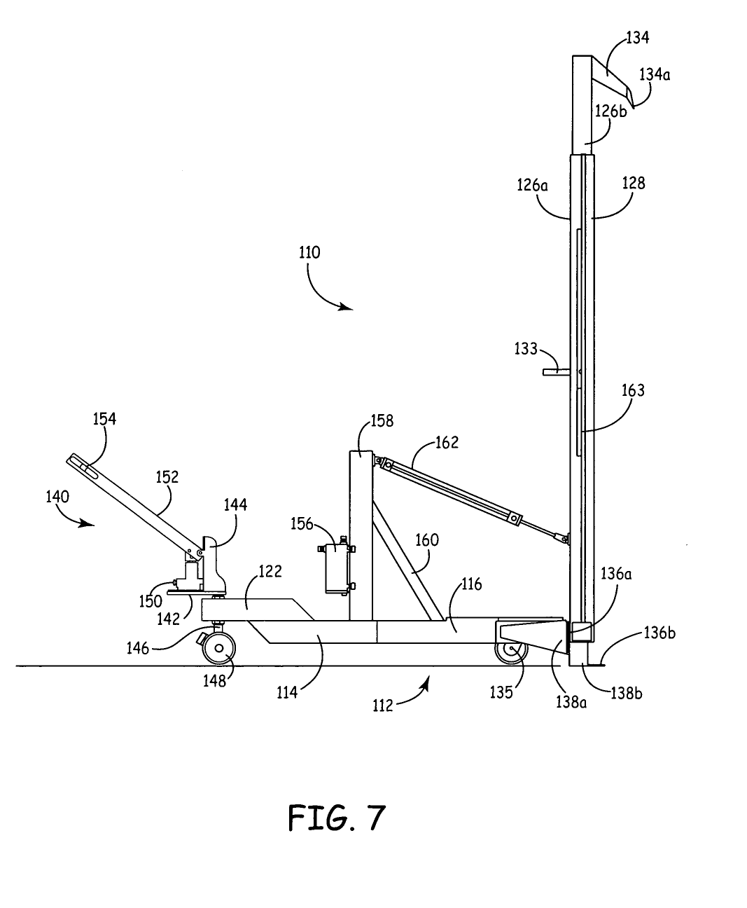

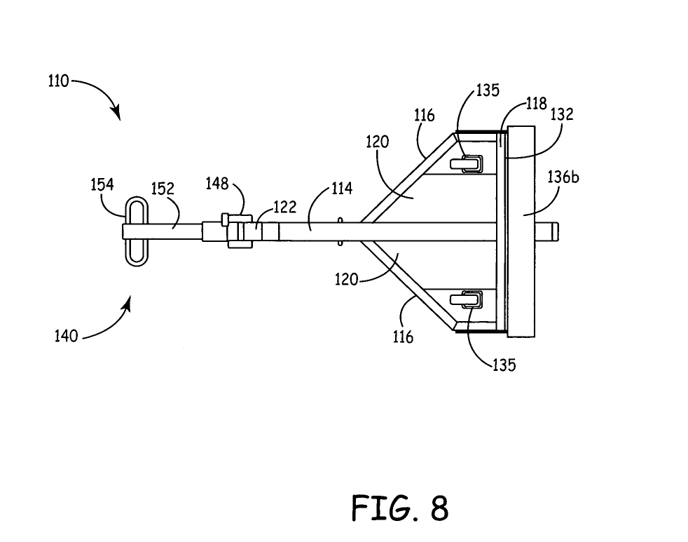

FIGS. 4-8 are a perspective view, a front view, a rear view, a side view, and a bottom view, respectively, of another embodiment of the wall transport device. In the embodiment shown in FIGS. 4-8, wall transport device 110 includes base 112 (which is formed by center bar 114, yoke members 116, cross bar 118, plates 120 and tongue 122), vertical support frame 124 (which is formed by mast 126, truss members 128, upright members 130, and bottom member 132), pin 133, slots 133a, hook 134, tooth 134a, wheels 135, angle plate 136 (which includes vertical plate 136a and bottom flange 136b), side brackets 138a, and vertical support devises 138b. Wall transport device 110 also includes steering/pump assembly 140 (which is formed by plate 142, mounting bracket 144, shaft 146, steerable wheels 148, hydraulic pump 150, arm 152 and handle 154), reservoir 156, post 158, strut 160, tilt cylinder 162 and clamping cylinder 163. Also shown are pivot axis P1 and pivot axis P2.

Base 112 provides the structural platform for wall transport device 110. Center bar 114 extends down the center of base 112 and is attached to cross bar 118 at a distal end of wall transport device 110 and to tongue 122 at a proximal end of wall transport device 110. Yoke members 116 are attached to center bar 114 and branch outward from center bar 114 in a distal direction to attach to cross bar 118. Plates 120 are located on each side of base 112 and are each attached to yoke member 116 and cross bar 118. Wheels 135 are connected to the bottom surfaces of plates 120.

Vertical support frame 124 is connected to base 112 through bottom member 132, devises 138b, angle plate 136 and side brackets 138a. Telescoping mast 126 is attached to bottom member 132 and extends in an upward direction. Upright members 130 each extend from an outer end of bottom member 132 and are attached to mast 126 via truss members 128. Telescoping mast 126 includes outer sleeve 126a and inner shaft 126b to which hook 134 is connected. Tooth 134a is attached to the tip of hook 134. Pin 133 is attached to inner shaft 126b and extends through outer sleeve 126a. Pin 133 may be moved up or down and inserted though slots 133a to control how high inner shaft 126b is allowed to extend from outer sleeve 126a.

Vertical support frame 124 is pivotally attached to angle plate 136, which includes vertical plate 136a and bottom flange 136b. Side devises 138a pivotally connect angle plate 136 to base 112. Vertical support bracket 138b pivotally connects vertical support frame 124 to angle plate 136. Side brackets 138a pivot about pivot axis P1 and vertical support crevises 138b pivot about pivot axis P2.

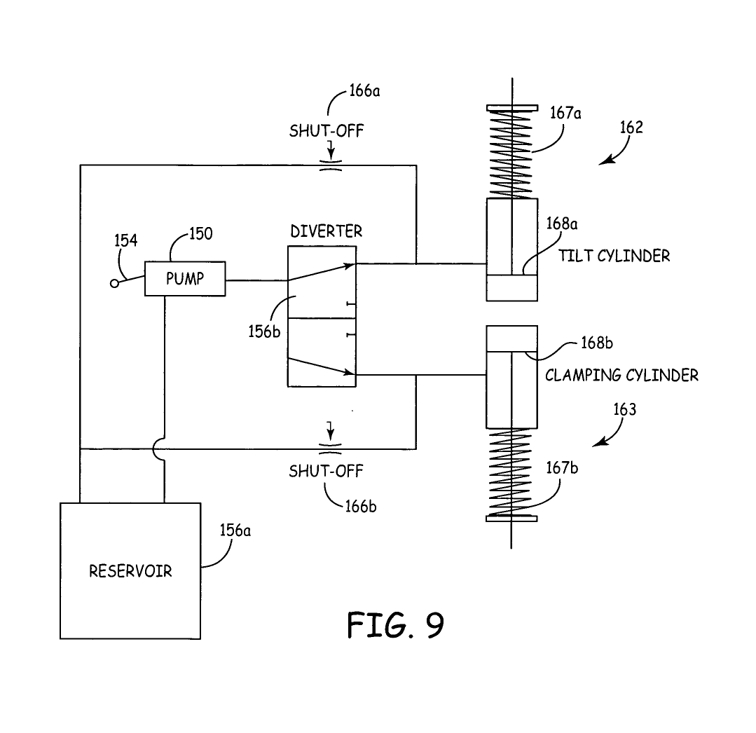

Wall transport device 110 also includes steering/pump assembly 140, which is attached to tongue 122 of base 112 by plate 142. Mounting bracket 144 and hydraulic pump 150 are attached to the top of plate 142. Arm 152 extends from mounting bracket 144 and handle 154 is connected to an outer end of arm 152. Handle 154 is moved up and down to operate hydraulic pump 150 (which is described in detail with reference to FIG. 9.) Shaft 146 extends though tongue 122 and is connected to handle 154. Wheels 148 are attached to shaft 146. In an exemplary embodiment, steering/pump assembly 140 is capable of rotating around a vertical axis with respect to base 112. As an operator rotates handle 154, wheels 148 rotate accordingly. Steering/pump assembly 140 has a range of motion of about 180 degrees. This allows an operator more maneuverability of wall transport device 110.

Vertical support frame 124 of wall transport device 110 is capable of moving between a frontward tilted position to a rearward tilted position via a hydraulic pump system. (The hydraulic pump system is described in detail with reference to FIG. 9.) As explained, hydraulic pump 150 is attached to handle 154 such that when handle 154 is moved up and down, hydraulic pump 150 is operated. Reservoir/diverter 156 is mounted on post 158, which extends from center bar 114 and is braced with strut 120. Reservoir/diverter 156 contains hydraulic fluid and controls where the hydraulic fluid is directed. Tilt cylinder 162 extends between post 158 and mast 126 and is in communication with reservoir/diverter 156. The movement of vertical support frame 124 is controlled by a flow of hydraulic fluid to and from tilt cylinder 162.

The telescoping mast 126 of wall transport device 110 is also capable of extending or retracting via the hydraulic pump system. (The hydraulic pump system is described in detail with reference to FIG. 9.) Clamping cylinder 163 is disposed within outer sleeve 126a of telescoping mast 126 and is in connection with inner shaft 126b. The movement of telescoping mast 126 is controlled by diverting hydraulic fluid through clamping cylinder 163.

FIG. 9 is a schematic diagram of the hydraulic pump system used in wall transport device 110. Shown are pump 150, handle 154, reservoir 156a, diverter 156b, tilt cylinder 162, clamping cylinder 164, shut-off valves 166a and 166b, springs 167a and 167b, and pistons 168a and 168b. In the proceeding figures, the fluid connections shown in FIG. 9 have been omitted for ease of illustration.

The hydraulic pump system is used to move vertical support frame 124 from a distal (frontward) tilted position to a proximal (rearward) tilted position by setting diverter 156b to select tilt. When vertical support frame 124 is in the proximal tilted position, tilt cylinder 162 is biased by spring 167a and is, therefore, at its longest (extended) length. Tilt cylinder 162 presses against vertical support frame 124 causing it to tilt distally. Handle 154 is then moved up and down to operate pump 150, which pumps fluid from reservoir 156a though diverter 156b to tilt cylinder 162. As hydraulic fluid enters tilt cylinder 162, tilt cylinder 162 gets shorter, exerting a pulling force on vertical support frame 124. When vertical support frame 124 reaches its rearward (proximal) tilted position, pumping can cease and tilt cylinder 162 will hold its length.

In order to move vertical support frame 124 back into the distal tilted position, shut-off (or bleed) valve 166a is pressed (opened) and fluid is allowed to return from tilt cylinder 162 to reservoir 156a. Spring 167a will move piston 168a within tilt cylinder 162 to force the hydraulic fluid out of tilt cylinder 162 through shut-off valve 166a to reservoir 156a until shut-off valve 166a is released (closed). When vertical support frame 124 reaches its frontward (distal) tilted position, tilt cylinder 162 will once again hold its length.

The hydraulic pump system is also used move telescoping mast 126 from an extended position to a retracted position by setting diverter 156b to select clamping. When vertical support frame is in the extended position, clamping cylinder 163 is biased by spring 167b and is, therefore, at its longest (extended) length. Clamping cylinder 163 presses against inner shaft 126b of telescoping mast 126 causing it to extend from outer sleeve 126a. Handle 154 is then moved up and down to operate pump 150, which pumps fluid from reservoir 156a though diverter 156b to clamping cylinder 163. As hydraulic fluid enters clamping cylinder 163, clamping cylinder 163 gets shorter, exerting a pulling force on inner shaft 126b. When mast 126 reaches its retracted position, pumping can cease and clamping cylinder 163 will hold its length.

In order to move telescoping mast 126 back into the extended position, shut-off valve 166b is pressed and fluid is allowed to return from clamping cylinder 163 to reservoir 156a. Spring 167b will move piston 168b within clamping cylinder 163 to force the hydraulic fluid out of clamping cylinder 163 through shut-off valve 166b to reservoir 156a until shut-off valve 166b is released. When mast 126 reaches its extended position, clamping cylinder 163 will once again hold its length.

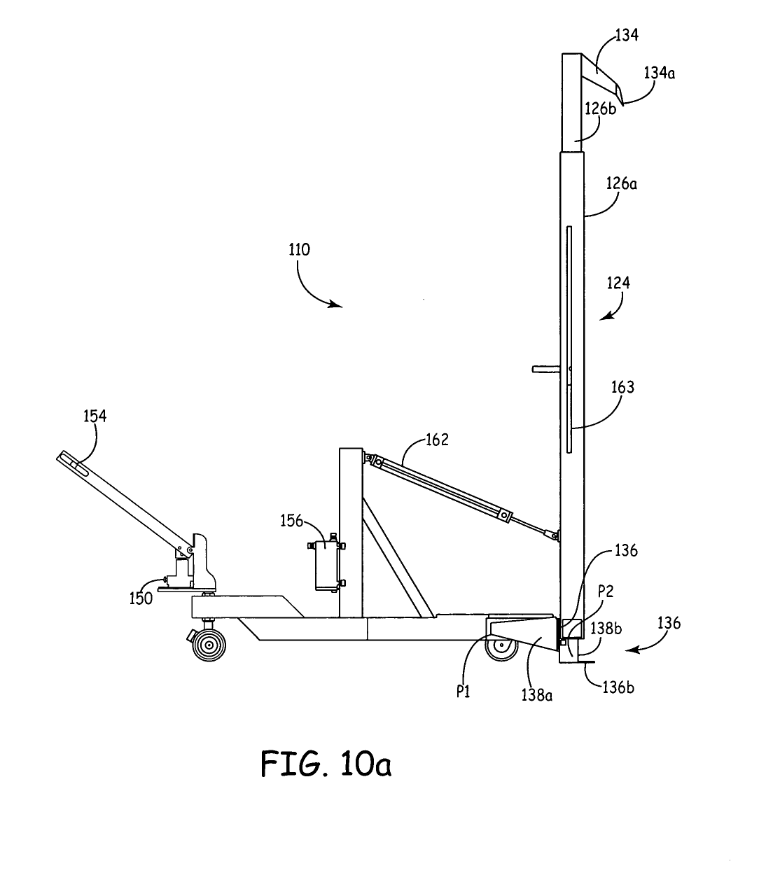

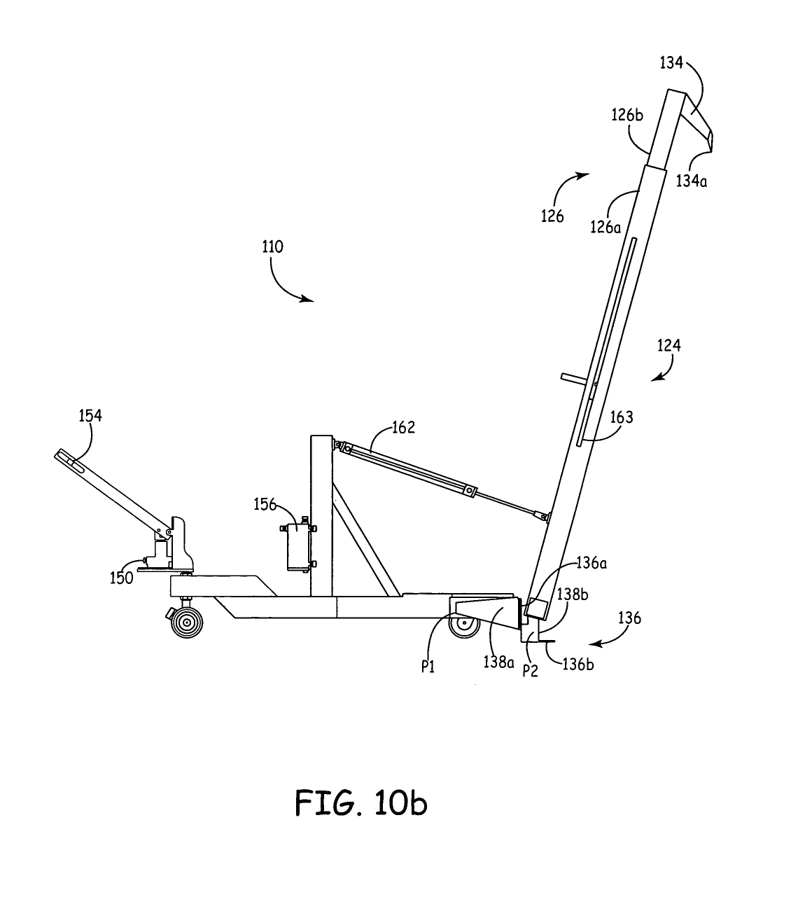

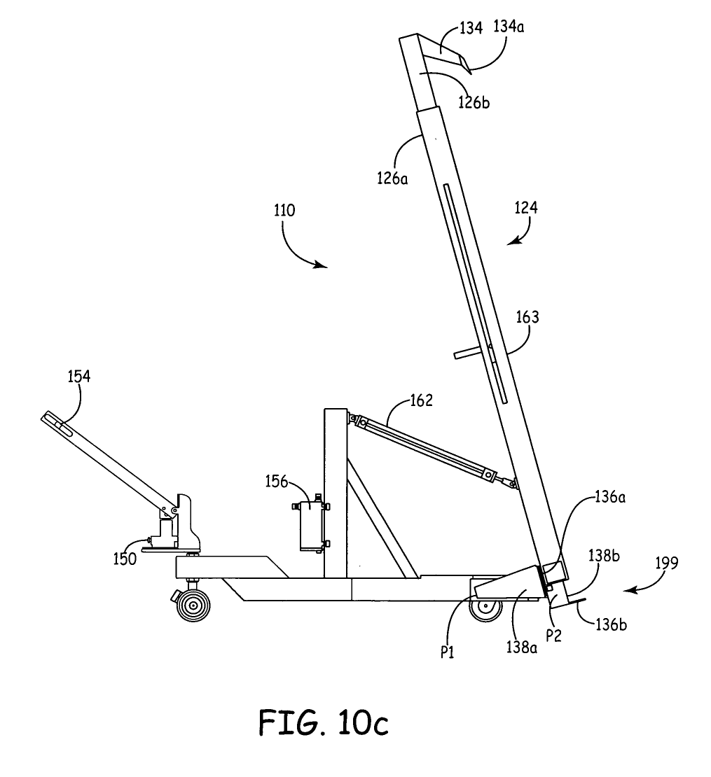

FIGS. 10a-10c demonstrate wall transport device 110 in operation. In FIG. 10a, wall transport device 110 is in an upright position. In order to utilize wall transport device 110, an operator must operate the hydraulic pump system to move vertical support frame into a distal tilted position. This is accomplished by lengthening tilt cylinder 162 (as described in detail with reference to FIG. 9).

FIG. 10b is a side view of wall transport device 110 in a distal position. In the exemplary embodiment shown in FIG. 10b, vertical support frame 124 is tilted about 10 degrees in a distal direction. As described with reference to FIGS. 4-8, vertical support frame 124 is attached to angle plate 136, which includes vertical plate 136a and bottom flange 136b. Vertical support devises 138b pivotally connect vertical support frame 124 to angle plate 136. As vertical support frame tilts in the distal direction, vertical support bracket 138b pivots about pivot axis P2. As a result, when vertical support frame 124 tilts forward, bottom flange 136b remains in a horizontal position against the floor (or other surface upon which wall transport system 110 is resting). This is advantageous when wall transport device is used to load a wall panel because bottom flange 136b can be easily slipped under a lower end of the wall.

The wall (not shown) is stacked against a vertical surface or another wall section so that it is tilted about 10 degrees in the distal direction. Once wall transport device 110 is properly positioned, wall transport device 110 is advanced such that bottom flange 136b slides under a bottom end of the wall. Since vertical support frame 124 has been tilted about 10 degrees in the distal direction, angle plate 136 fits snuggly against the wall. Hook 134 is positioned above the wall and then is moved downward by setting diverter 156b to clamping and pumping handle 154 up and down to retract clamping cylinder 163 (as described in detail with reference to FIG. 9) so that the wall is clamped between hook 134 and bottom flange 136b. In this clamping process, only tooth 134a of hook 134 may engage the upper end of the wall, but that will provide adequate clamping to allow the wall to be tilted rearwardly. Hook 134 can be repositioned so that tooth 134a engages the side rather than the top of the wall.

Vertical support frame is then tilted rearwardly by setting diverter 156b to tilt and pumping handle 154 up and down to retract tilt cylinder 162 (as described in detail with reference to FIG. 9).

FIG. 10c is a side view of wall transport device 110 tilted in the proximal (rearward) direction. As shown in FIG. 10c, vertical support frame 124 tilts about 10 degrees in a proximal direction. As described with reference to FIGS. 4-8, side bracket 138a pivotally connects angle plate 136 to base 112. As vertical support frame tilts rearward, side bracket 138a pivots about pivot axis P1. As a result, when vertical support frame 124 tilts in the proximal direction, it exerts pressure on vertical plate 136a. As vertical support frame continues to tilt proximally, the pressure causes side bracket 138a to pivot in an upward direction around pivot axis P1. As a result, bottom flange 136a and vertical support frame bracket 138b are also pulled in an upward direction. Wall is now tilted and remains clamped between hook 134 and bottom flange 136b.

An operator can now safely and efficiently transport the wall. When the wall is properly positioned at the installation site, the operator may press shut-off valve 166a to release the hydraulic fluid from tilt cylinder 162. As a result, the wall will tilt in a proximal direction until bottom flange 136b is withdrawn from under the lower end of the wall. The wall may then be positioned upright with hook 134 still in place for security purposes. The operator, or other workers, can now safely nail/bolt the wall into place. When the wall is installed, the operator may press shut-off valve 166b to release the hydraulic fluid from clamping cylinder 163. As a result, hook 134 is raised, which separates wall transport device 110 from the wall panel.

Although the present invention has been described with reference to preferred embodiments, workers skilled in the art will recognize that changes may be made in form and detail without departing from the spirit and scope of the invention.

1. A wall transport device, the device comprising:
a base having upper and lower surfaces and proximal and distal ends;
a plurality of wheels positioned below the base;
a steering assembly attached to the proximal end of the base, the steering assembly including a handle and at least one steerable wheel;
a wall support pivotally connected to the distal end of the base, the wall support including a telescoping mast, a top hook, and a bottom flange;
a first mechanism for tilting the wall support between a proximal position and distal position; and
a second mechanism for raising and lowering the top hook.

2. The wall transport device of claim 1, wherein the first and second mechanisms are manually operated.

3. The wall transport device of claim 2, and further comprising:
a first lever attached to the wall support.

4. The wall transport device of claim 3, wherein the wall support is tilted in a proximal direction when a downward force is applied to the first lever.

5. The wall transport device of claim 3, wherein the wall support is tilted in a distal direction when an upward force is applied to the first lever.

6. The wall transport device of claim 2, and further comprising:
a second lever attached to the top hook with a linkage component.

7. The wall transport device of claim 6, wherein the top hook is lowered when a downward force is applied to the second lever.

8. The wall transport device of claim 6, wherein the top hook is raised when an upward force is applied to the second lever.

9. The wall transport device of claim 1, wherein the first and second mechanisms are hydraulically powered.

10. The wall transport device of claim 9, and further comprising:
a hydraulic system for operating the first and second mechanisms.

11. The wall transport device of claim 10, and further comprising:
a tilt cylinder for operating the first mechanism.

12. The wall transport system of claim 11, and further comprising:
a clamping cylinder for operating the second mechanism.

13. The wall transport device of claim 12, and further comprising:
a valve for controlling delivery of hydraulic fluid to the tilt and clamping cylinders.

14. The wall transport device of claim 1, wherein the first mechanism is capable of tilting the wall support at least 10 degrees in a proximal direction.

15. The wall transport device of claim 1, wherein the first mechanism is capable of tilting the wall support at least 10 degrees in a distal direction.

16. The wall transport device of claim 1, wherein the steering assembly is capable of rotating about a vertical axis with respect to the base.

17. The wall transport device of claim 1, wherein the steering assembly has a range of motion of 180 degrees.

19. The wall transport device of claim 1, wherein the telescoping mast and the bottom flange are pivotally connected such when the telescoping mast is tilted in a distal direction the bottom flange remains in a horizontal orientation.
